(19) United States
(12) Patent Application Publication
(10) Pub. No.: US 2003/0224853 A1
(43) Pub. Date: Dec. 4, 2003

(54) Prize recreational machine

(76) Inventor: Felix Guindulain Vidondo, Peralta (ES)

Correspondence Address: KLAUBER & JACKSON, 411 HACKENSACK AVENUE, HACKENSACK, NJ, 07601

(21) Appl. No.: 10/420,627

(22) Filed: Apr. 22, 2003

(30) Foreign Application Priority Data
May 30, 2002 (ES) P200201239

(51) Int. Cl. G07F 17/34

(52) U.S. Cl. 463/20

(57) ABSTRACT

Prize recreational machine, being of the type of prize recreational machine that functions by means of the insertion of coins and can have very variable game dynamics, and presenting the corresponding operating push-buttons, the machine (1) comprising a set (2) in which are grouped a mouth (3) for insertion of coins with a guiding duct to the validation selector, a mouth (4) for the introduction of banknotes, related to the validation device for them, and a collector (5) for collecting the coins expelled from the machine, all of them being in proximity and at an ergonomic height.

### OBJECT OF THE INVENTION

As stated in the title of the present descriptive specification, the invention that follows refers to a prize recreational machine, being of the type of prize recreational machine that functions by means of inserting coins and awarding cash prizes, in such a way that the recreational machine presents a unit in which are grouped a mouth for the insertion of coins with a guiding duct to the selector, a note-slot with the mouth for the introduction of banknotes, related to the validation device for them, and a collector or container for withdrawal by the user, which is placed in a very ergonomic position.

So, by means of this structure, it is made easier for users to be able to play the game comfortably since, whether the game is played either standing or seated, the player has perfect accessibility to all the elements and, primarily, to the deposit and collector for collecting the coins.

### FIELD OF APPLICATION OF THE INVENTION

The prize recreational machine that is presented is of the type of prize machine which functions by means of inserting coins, this machine being able to present a great diversity of games.

### BACKGROUND OF THE INVENTION

As is known, there exists a great diversity of prize recreational machines on the market, which can present very different game dynamics, in such a way that, in principle, the same prize recreational machines in the past used to function solely by means of the insertion of coins, but with time some types of machine have incorporated a “note-slot” for validation of banknotes, so that they can be accepted.

In this way, recreational machines have been presenting a mouth for the insertion of coins for being led to the corresponding coin validator, in such a way that this mouth for the insertion of coins is provided at a suitable height for facilitating the operation of introducing the coins, permitting this to be done comfortably both if the user is standing and if he/she is sitting on a stool, the stool being of the type of those conventionally existing in bars, restaurants and similar, so that users can sit and adopt a comfortable position of access to the bar.

As certain types of recreational machine incorporate “note-slots” for the acceptance of banknotes, these have been positioned in a place away from the mouth for the insertion of coins, though also in a suitable place for facilitating the operation of introducing the notes, permitting this to be done comfortably both if the user is standing and if he/she is sitting on a stool of the type mentioned above.

Moreover, the deposit container or collector where the coins rejected by the validator and change are led, along with coins awarded in payment of prizes won, is located in a position beneath the operating push-buttons, and of course beneath the mouth for the insertion of coins and the “note-slot”, with the coin withdrawal collector or container extending across the entire front of the actual structure of the machine.

This structuring of the prize recreational machine, provided with a deposit collector or container for the coins to which they are led when returned by the selector, when giving change or awarding the corresponding prizes, in a position that is very low down, is highly inconvenient for users when it comes to withdrawing the coins led to it, and this situation is aggravated when the user is playing sitting on a stool since he/she must normally stand up to withdraw the coins from the container or collector.

### DESCRIPTION OF THE INVENTION

This descriptive specification describes a prize recreational machine, being of the type of prize recreational machine that functions by means of inserting coins and which can have very variable game dynamics, and which presents the corresponding operating push-buttons, in such a way that the prize recreational machine comprises a unit in which are grouped a mouth for the insertion of coins with a guiding duct to the selector, a mouth for the introduction of banknotes, related to the validation device for them, and a collector or container for coins expelled by the machine, all of them in proximity and at an ergonomic height.

So, users are facilitated in playing the game since they can do this comfortably, whether they are standing or whether they are sitting on a stool of the type conventionally used in bars, restaurants and similar, given that it has perfect and comfortable accessibility to all the elements necessary for playing the game, as well as for withdrawing the coins led to and deposited in the collector.

In a variant of the practical design of the invention, the prize recreational machine is suitable for presenting a unit in which are grouped a mouth for the insertion of coins with a guiding duct to the selector and a collector or container for collecting the coins expelled by the machine, all of them in proximity and at an ergonomic height.

This design is valid for those machines which do not incorporate a banknote validator device.

Moreover, the withdrawal collector for the coins is positioned on the mounting surface for the operating push-buttons, slightly inclined with respect to a free side and easily accessible to users.

In order to complement the description that is going to be made forthwith, and with the aim of aiding a better understanding of the characteristics of the invention, the present descriptive specification is accompanied by a set of drawings, with figures representing the most characteristic details of the invention in a way that is to be regarded as illustrative rather than limiting.

### BRIEF DESCRIPTION OF THE DRAWINGS

FIG. 1. Shows a perspective view of a prize recreational machine, in which can be seen how the mouth for insertion of coins, the mouth for introduction of banknotes and the withdrawal collector for the coins are to be found grouped in a place having comfortable accessibility for users.

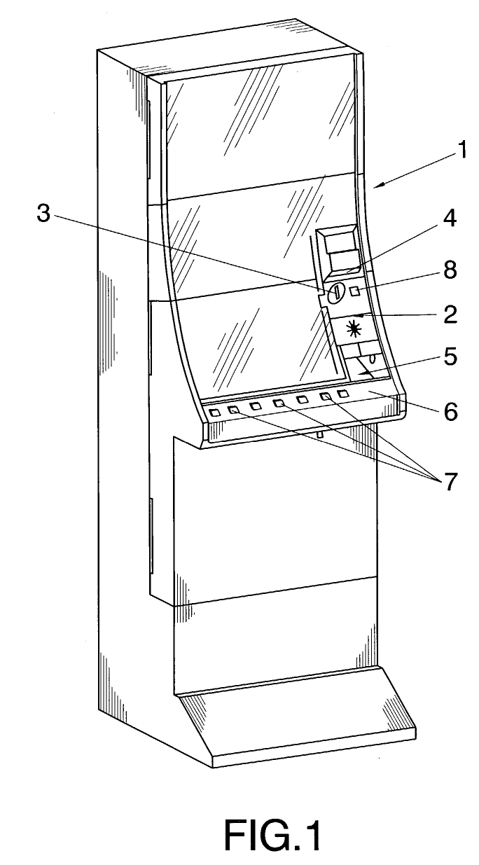

FIG. 2. Shows a front view of the prize recreational machine, relative to the previous figure, where it can likewise be seen how the mouth for insertion of coins, the mouth for introduction of banknotes and the withdrawal collector for the coins are to be found grouped in a place having comfortable accessibility for users.

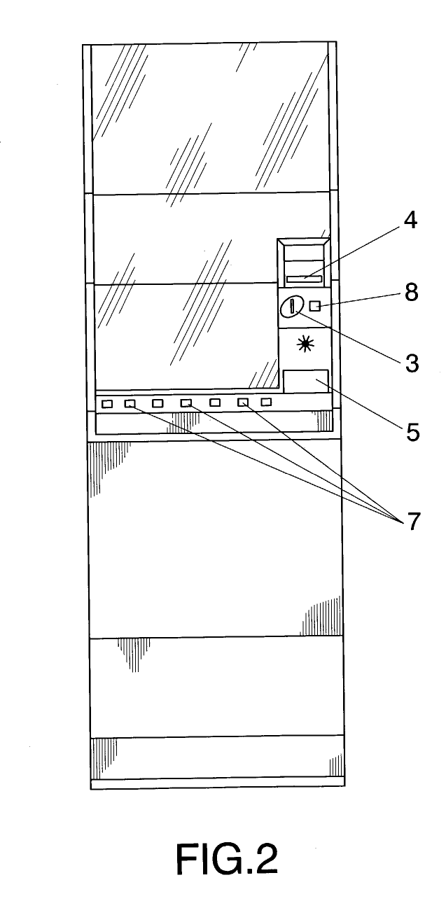

### DESCRIPTION OF AN EMBODIMENT OF THE INVENTION

In view of the aforementioned figures and in accordance with the numbering adopted therein, we can see how the prize recreation machine 1, which awards cash prizes, comprises a unit 2 in which are grouped a mouth 3 for the insertion of coins related to the duct for guiding the introduced coins to the selector for their validation, a mouth 4 for the introduction of banknotes related to the validation device for them, and a collector 5 for collecting the coins expelled by the machine, all of them being in proximity and at an ergonomic height.

In a practical design of the invention, the prize recreational machine 1 comprises a unit 2 in which are grouped a mouth 3 for the insertion of coins related to the duct for guiding the introduced coins to the selector and a collector 5 for collecting the coins expelled by the machine, all of them being in proximity and at an ergonomic height, in other words, in this practical design the machine lacks the “note-slot”.

Moreover, the withdrawal collector 5 for the coins, whether they be coins rejected by the validation selector, coins related to possible change, or those related to payment of cash prizes, is positioned on the mounting surface 6 of the operating push-buttons 7, with respect to a free side.

So, all the elements required for playing the game are to be found at an appropriate height for facilitating the game for the users, and, primarily, the withdrawal collector 5 for the coins since, as they are located on the mounting surface for the operating push-buttons, users can access it in a way that is comfortable, whether they are standing or sitting on a stool of the type conventionally existing in bars, restaurants, etc.

1. PRIZE RECREATIONAL MACHINE, being of the type of prize recreational machines that function by means of inserting coins, which admit very variable game dynamics and presenting corresponding function push-buttons, wherein the prize recreational machine comprises a set in which are grouped a mouth for inserting coins with a guiding duct to a validation selector, and a collector for collecting coins expelled by the prize recreational machine, all being in proximity and at an ergonomic height.

2. PRIZE RECREATIONAL MACHINE, according to claim 1, wherein the set of the prize recreational machine additionally comprises a mouth for inserting banknotes related to a validation device for banknotes, said mouth for inserting banknotes also being at an ergonomic height and in proximity with the mouth for inserting coins and with the collector for collecting coins.

3. PRIZE RECREATIONAL MACHINE, according to claim 1, wherein the collector for collecting expelled coins is positioned on a mounting surface of the function push-buttons, with respect to a free side.

4. PRIZE RECREATIONAL MACHINE, according to claim 2, wherein the collector for collecting expelled coins is positioned on a mounting surface of the function push-buttons, with respect to a free side.
